(19) United States
(12) Patent Application Publication
(10) Pub. No.: US 2018/0074198 A1
(43) Pub. Date: Mar. 15, 2018

(54) OPTICAL BEAM IDENTIFICATION USING OPTICAL DEMODULATION

(71) Applicant: QUALCOMM Incorporated, San Diego, CA (US)

(72) Inventors: William Henry Von Novak, San Diego, CA (US); Linda Irish, San Diego, CA (US)

(21) Appl. No.: 15/266,969

(22) Filed: Sep. 15, 2016

(51) Int. Cl. G01S 17/32; G02B 26/04; G01S 7/491

(52) U.S. Cl. CPC G01S 17/32; G01S 7/4911; G02B 26/04

(57) ABSTRACT

Disclosed herein are techniques for identifying optical beams incident upon a sensor of a light detection and ranging (LIDAR) system. In certain aspects, a sensor coupled to the LIDAR system receives a first optical beam comprising a first frequency and a second optical beam comprising a second frequency. The LIDAR system may include a shutter coupled to the sensor and configured to operate at a third frequency, wherein operating the shutter while receiving the first optical beam comprising the first frequency results in a first signal with a fourth frequency and operating the shutter while receiving the second optical beam comprising the second frequency results in a second signal with a fifth frequency. Furthermore, the LIDAR system may include processing logic configured to detect the first signal with the fourth frequency and identify the first optical beam using a known association between the first optical beam and the fourth frequency.

### BACKGROUND

A light detection and ranging (LIDAR) system is an active remote sensing system that can be used to obtain the range, i.e., distance, from a source to one or more points on a target. LIDAR systems may be used in areas such as self-driving cars, security systems, drones, etc. A LIDAR system uses an optical beam (typically a laser beam) to illuminate a target and senses the reflected optical beam from the target at a sensor source or at a known location. The LIDAR system may use an angle of the reflected optical beam or time-of-flight for the optical beam to the target and back in determining the distance between the LIDAR system and the target.

### BRIEF SUMMARY

Systems, methods, apparatus and non-transitory computer medium storage for storing instructions are disclosed for generally improving distance determination for an object at a distance from a LIDAR system and particularly identifying an optical beam for determining such a distance.

As disclosed herein, according to certain aspects of the disclosure, optical modulation and demodulation may be used to uniquely identify and/or associate an optical beam with a LIDAR device. The optical beam emitting from a transmitter of the LIDAR system may be modulated with a characteristic frequency. The sensor or detector at a receiver of the LIDAR system may contain a shutter that operates relatively close to this characteristic frequency. The combination of the modulated optical beam and the shutter operating at a relatively close frequency to the modulated optical beam results in a unique “beat” frequency that can be used to identify the optical beam associated with the transmitter of the LIDAR system or the LIDAR system of interest.

In accordance with an example implementation, a method for identifying an optical beam at a device is disclosed. An example method for identifying an optical beam may include receiving, at the device, a first optical beam comprising a first frequency; receiving, at the device, a second optical beam comprising a second frequency; operating, by the device, a shutter at a third frequency, wherein operating the shutter while receiving the first optical beam comprising the first frequency results in a first signal with a fourth frequency and operating the shutter while receiving the second optical beam comprising the second frequency results in a second signal with a fifth frequency; detecting, by the device, the first signal with the fourth frequency; and identifying, by the device, the first optical beam using a known association between the first optical beam and the fourth frequency by the device.

In certain examples, the first optical beam may be generated by the device and reflected off of an object and received back at the device. The first optical beam may be generated using a continuous wave laser.

In certain instances, the method may further include determining a distance of the object from the device using information associated with the first optical beam after identifying the first optical beam. In certain instances, the method may also include detecing the second signal with the fifth frequency and identifying the second optical beam using a second known association between the second optical beam and the fifth frequency by the device.

In certain instances, the second optical beam may be generated by the device and reflected off of an object and received back at the device. The method may also include determining a distance of the object from the device using information associated with the second optical beam after identifying the second optical beam.

In certain instances, the second optical beam may be generated by a source other than the device. In certain instances, the first frequency is at least twice the third frequency.

In certain implementations, the shutter may be a physical shutter and wherein operating the shutter at the third frequency may include repeatedly opening the shutter for a first period of time and closing the shutter for a second period of time, wherein opening the shutter allows passage of light received at the device through the shutter to the senor and closing the shutter obscures the sensor from receiving light received at the device. In implementations where the shutter is a physical shutter the first signal and the second signal may be optical signals or optical beams. For example, the first signal may be a third optical beam with the fourth frequency and the second signal may be fourth optical beam with the fifth frequency. In other implementations, the shutter may be a digital shutter, wherein operating the shutter at the third frequency comprises disabling sensing, blanking sensing, or disregarding sensed information for a first period of time repeatedly at a fixed rate based on the selected third frequency. In implementations where the shutter is a digital shutter, the first signal and the second signal may be digital signals.

In accordance with another example implementation, a device for identifying an optical beam may be provided which includes a sensor coupled to the device and configured to receive a first optical beam comprising a first frequency and receive and a second optical beam comprising a second frequency. The device may also include a shutter coupled to the sensor and configured to operate at a third frequency, wherein operating the shutter while receiving the first optical beam comprising the first frequency results in a first signal with a fourth frequency and operating the shutter while receiving the second optical beam comprising the second frequency results in a second signal with a fifth frequency, and processing logic configured to detect the first signal with the fourth frequency and identify the first optical beam using a known association between the first optical beam and the fourth frequency by the device.

In certain implementations of the device, the first optical beam may be generated by a laser coupled the device and reflected off of an object and received back at the sensor. The first optical beam may be generated using a continuous wave laser. In certain instances, the processing logic may be further configured to determine a distance of the object from the device using information associated with the first optical beam after identifying the first optical beam. In certain instances, the processing logic further may be further configured to detect the second signal with the fifth frequency and identify the second optical beam using a second known association between the second optical beam and the fifth frequency by the device.

The second optical beam may be generated by a laser coupled to the device and reflected off of an object and received back at the sensor. In certain example implementations, the processing logic may be further configured to determine a distance of the object from the device using information associated with the second optical beam after identifying the second optical beam.

In certain instances, the second optical beam may be generated by a source other than the device. In certain instances, the first frequency is at least twice the third frequency.

In certain aspects of the disclosure, the shutter may be a physical shutter and wherein operating the shutter at the third frequency may include repeatedly opening the shutter for a first period of time and closing the shutter for a second period of time, wherein opening the shutter allows passage of light received at the device through the shutter to the senor and closing the shutter obscures the sensor from receiving light received at the device. In implementations where the shutter is a physical shutter the first signal and the second signal may be optical signals or optical beams. For example, the first signal may be a third optical beam with the fourth frequency and the second signal may be fourth optical beam with the fifth frequency. In other implementations, the shutter may be a digital shutter, wherein operating the shutter at the third frequency comprises disabling sensing, blanking sensing, or disregarding sensed information for a first period of time repeatedly at a fixed rate based on the selected third frequency. In implementations where the shutter is a digital shutter, the first signal and the second signal may be digital signals.

In accordance with yet another example implementation, a non-transitory computer-readable storage medium including machine-readable instructions stored thereon for receiving a first optical beam comprising a first frequency, receiving a second optical beam comprising a second frequency, operating a shutter at a third frequency, wherein operating the shutter while receiving the first optical beam comprising the first frequency results in a first signal with a fourth frequency and operating the shutter while receiving the second optical beam comprising the second frequency results in a second signal with a fifth frequency, and detecting the first signal with the fourth frequency and identifying the first optical beam using a known association between the first optical beam and the fourth frequency.

In certain aspects, the first optical beam may be generated by the device and reflected off of an object and received back at the device. The first optical beam may be generated using a continuous wave laser.

In certain instances, the non-transitory computer-readable storage medium may further include instructions for determining a distance of the object from the device using information associated with the first optical beam after identifying the first optical beam. In certain implementations, the non-transitory computer-readable storage medium method may also include instructions for detecing the second signal with the fifth frequency and identifying the second optical beam using a second known association between the second optical beam and the fifth frequency by the device.

In certain instances, the second optical beam may be generated by the device and reflected off of an object and received back at the device. The method may also include determining a distance of the object from the device using information associated with the second optical beam after identifying the second optical beam.

In certain instances, the second optical beam may be generated by a source other than the device. In certain instances, the first frequency is at least twice the third frequency.

In certain aspects of the disclosure, the shutter may be a physical shutter and wherein operating the shutter at the third frequency may include repeatedly opening the shutter for a first period of time and closing the shutter for a second period of time, wherein opening the shutter allows passage of light received at the device through the shutter to the senor and closing the shutter obscures the sensor from receiving light received at the device. In implementations where the shutter is a physical shutter the first signal and the second signal may be optical signals or optical beams. For example, the first signal may be a third optical beam with the fourth frequency and the second signal may be fourth optical beam with the fifth frequency. In other implementations, the shutter may be a digital shutter, wherein operating the shutter at the third frequency comprises disabling sensing, blanking sensing, or disregarding sensed information for a first period of time repeatedly at a fixed rate based on the selected third frequency. In implementations where the shutter is a digital shutter, the first signal and the second signal may be digital signals.

According to certain aspects of the disclosure, an example apparatus, such as a device, for identifying an optical beam may include means for receiving, at a device, a first optical beam comprising a first frequency, means for receiving, at the device, a second optical beam comprising a second frequency, means for operating, by the device, a shutter at a third frequency, wherein operating the shutter while receiving the first optical beam comprising the first frequency results in a first signal with a fourth frequency and operating the shutter while receiving the second optical beam comprising the second frequency results in a second signal with a fifth frequency, and means for identifying, by the device, the first optical beam using a known association between the first optical beam and the fourth frequency by the device.

In certain example apparatus, the first optical beam may be generated using a continuous wave laser. In certain aspects, the example apparatus may also include detecting the second signal with the fifth frequency and identifying the second optical beam using a second known association between the second optical beam and the fifth frequency by the device. In certain instances, the second optical beam may be generated by a source other than the device.

### BRIEF DESCRIPTION OF THE DRAWINGS

Aspects of the present disclosure are illustrated by way of example. Non-limiting and non-exhaustive aspects are described with reference to the following figures, wherein like reference numerals refer to like parts throughout the various figures unless otherwise specified.

FIG. 1 is a block diagram that discloses an example device for laser distance measurement using triangulation.

FIG. 2 is an example block diagram that discloses an example device for laser distance measurement using time of flight measurement.

FIG. 3 is an example block diagram of an illustrative LIDAR system, according to certain aspects of the disclosure.

FIG. 4 is a block diagram that illustrates an example LIDAR system with the receiver for receiving optical beam reflections from multiple transmitters reflected off of multiple objects.

FIG. 5 is a block diagram that illustrates an example LIDAR system with the receiver for receiving optical beam reflections from multiple transmitters reflected off of the object and ambient light from a bright source.

FIG. 6 is a block diagram that illustrates an example LIDAR system with the receiver for receiving optical beam reflections from multiple transmitters reflected off of object and ambient light from a bright source, according to aspects of the disclosure.

FIG. 7 is a flow diagram illustrating a method for performing embodiments of the invention according to one or more illustrative aspects of the disclosure.

FIG. 8 is a flow diagram illustrating a method for performing embodiments of the invention according to one or more illustrative aspects of the disclosure.

FIG. 9 is an example block diagram that discloses example logic for performing one or more aspects of the disclosure.

FIG. 10 is a block diagram of an example computing system for implementing some of the examples described herein.

### DETAILED DESCRIPTION

Several illustrative embodiments will now be described with respect to the accompanying drawings, which form a part hereof. The ensuing description provides embodiment(s) only, and is not intended to limit the scope, applicability or configuration of the disclosure. Rather, the ensuing description of the embodiment(s) will provide those skilled in the art with an enabling description for implementing an embodiment. It is understood that various changes may be made in the function and arrangement of elements without departing from the spirit and scope of this disclosure.

A LIDAR system, also referred to as a laser detection and ranging (LADAR) system, is an active remote sensing system that can be used to obtain the range, i.e., distance, from a source to one or more points on a target. A LIDAR uses an optical beam, typically a laser beam, to illuminate one or more points on the target. Compared with other light sources, an optical beam may propagate over long distances without spreading significantly (i.e., it is highly collimated), and can be focused to small spots so as to deliver very high optical power densities and provide fine resolution. LIDAR systems may be used in areas such as self-driving cars, security systems, drones, etc.

Generally, LIDAR systems operate using optical beams at an optical spectrum with much faster frequency and smaller wavelength than radio waves, such as wavelength of 930-960 nm, 1030-1070 nm, or around 1550 nm. Because LIDAR systems operate at a speed and wavelength much different from radio detection and ranging (RADAR) systems that operate on radio waves, the same systems and techniques used in RADAR systems may not be adaptable for LIDAR systems. The logic used in a RADAR system can operate at a much slower speed and can therefore accommodate processing intensive and slow modulation and demodulation techniques. Furthermore, components of a RADAR system may also be significantly different from a LIDAR system. For example, a RADAR system uses an antennae and various analog circuitry to support the receiving of radio waves, whereas the LIDAR system uses one or more lenses, shutters and optical sensors in the receiver.

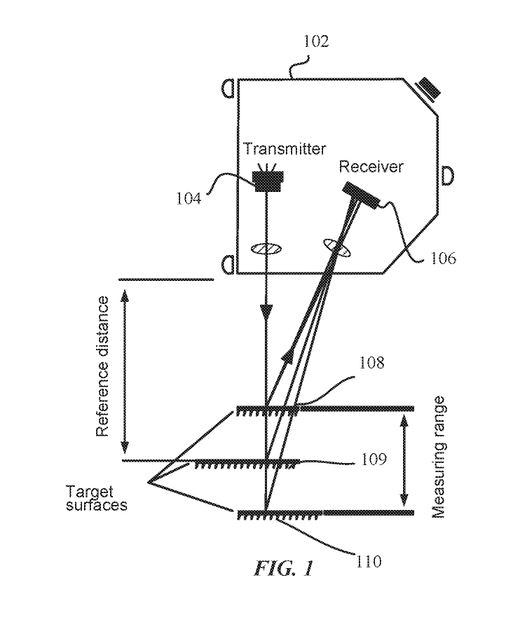

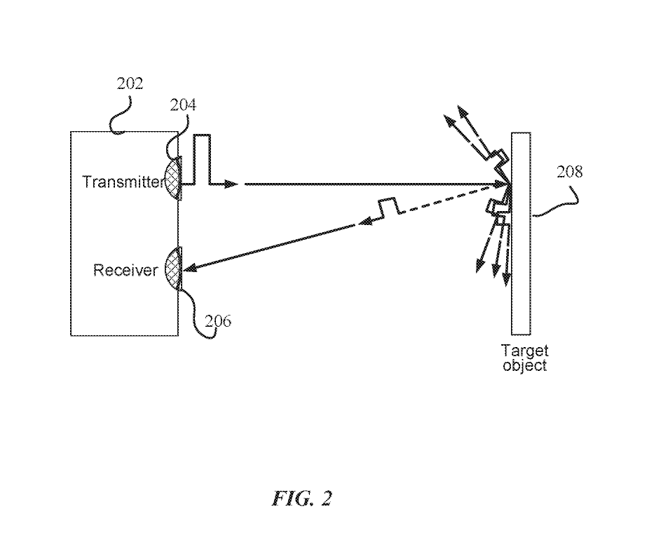

A LIDAR system may use an angle of the reflected optical beam (i.e., triangulation) or time-of-flight of the optical beam to the target and back in determining the distance between the LIDAR system and the target. Measuring distance using the angle of the reflected optical beam is described in more detail in FIG. 1 and measuring distance using time-of-flight is described in more detail in FIG. 2 below.

Both techniques described, with reference to FIG. 1 (i.e., triangulation) and FIG. 2 (i.e., time-of-flight), of determining distance using light ranging may experience interference from ambient light and/or other LIDAR systems. For example, in a tourist location several tourists may be using cameras that incorporate LIDAR systems that have similar optical beams generated and reflected off of surrounding surfaces. Furthermore, bright sources, such as the sun or a high beam automobile light may also interfere with detecting optical beams at the receiver of the LIDAR system. Filters can help alleviate some of the interference experienced from ambient light, however bright ambient light, such as solar illumination, contains component from several frequencies and increases the complexity of filtering out specific frequency bands. Furthermore, as more LIDARs use commonly available laser frequencies, more interference from other devices is encountered that is difficult to filter out because multiple devices use the same frequencies. Another technique for partially ameliorating interference is by using mechanical systems that align the receiver sensor with the laser transmitter, but this may be expensive and fragile and still susceptible to interference.

As disclosed herein, according to certain aspects of the disclosure, optical modulation and demodulation may be used to uniquely identify and/or associate an optical beam with a LIDAR device. The optical beam emitting from a transmitter of the LIDAR system may be modulated with a characteristic frequency. It should be noted that the optical beam itself has a frequency (i.e. 380 terahertz), that is much higher than the modulated characteristic frequency (e.g., around 20 KHz). The sensor or detector at a receiver of the LIDAR system may contain a shutter that operates relatively close to this characteristic frequency. The combination of the modulated optical beam and the shutter operating at a relatively close frequency to the modulated optical beam results in a unique signal with a “beat” frequency that can be used to identify the optical beam associated with the transmitter of the LIDAR system or the LIDAR system of interest.

Providing a signal with a “beat” frequency, as disclosed herein, in certain instances reduces the effect of the interference from the ambient light, allows identification of a certain optical beam associated with a particular LIDAR system as distinct from a plurality of optical beams from several LIDAR systems, and also allows detecting several optical beams for several different LIDAR system at the same time or substantially the same time. In certain embodiments, beat frequency of the signal is a frequency equal to the difference in the frequencies of two interacting signals, caused by periodic reinforcement and cancellation of the two signals. Furthermore, because the LIDAR device is detecting a signal with a certain “beat” frequency for a coherent signal, techniques disclosed herein can also lead to processing gain to increase the detector's signal to noise ratio.

Coherent signal or light from most lasers is different from the incoherent light that most light sources emit. Light emitted by normal means such as a flashlight or a bulb, is incoherent or the photons of the many wave frequencies of light are oscillating in different directions. In most lasers, waves are identical in frequency and in phase, which produces a beam of coherent light. There are many types of lasers that use gases such as helium, neon, argon, and carbon dioxide. Lasers also use semiconductors (Gallium and Arsenic), solid-state material (ruby, glass), and even chemicals (hydrofluoric acid) in their operation. In certain implementations, a continous wave laser may be used to generate a coherent wave that has a close to constant amplitude and frequence for the optical beam. The continous wave laser may be continously pumped and may continously emit the optical beam.

FIG. 1 is a block diagram that discloses an example device for laser distance measurement using triangulation. In FIG. 1, the device 102 may be an example LIDAR system that has a transmitter 104 and a receiver 106. The transmitter 104 may have a laser diode for transmitting optical beams. The transmitter 104 (i.e., the laser diode) projects an optical beam or spot of light on the target surfaces and its reflection is focused via an optical lens on a light sensitive sensor of the receiver 106. The receiver 106 may have a light sensitive sensor for detecting the optical beams emitted by the transmitter 104. FIG. 1 also illustrates several target surfaces (108, 109 and 110) placed at different distances relative to the device 102. The optical beam transmitted by the transmitter 104 reflects off of each of the target surfaces and is sensed by the receiver 106. Laser triangulation sensors at the receiver 106 determine the position of a target by measuring reflected optical beams from the target surface.

If the target surface changes its position, the position of the reflected optical beam on the sensor changes as well. For example, if the reflected optical beam moves away from the center of the sensor it indicate that the target surface has moved closer to the receiver 106. On the other hand, if the reflected optical beam moves closer to the center of the sensor, the target surface may have moved farther away from the receiver 106. In certain implementations, the signal conditioning electronics of the LIDAR system detects the position of the reflected optical beam on the receiving element of the sensor, performs linearization and additional digital and/or analog signal conditioning, and provides an estimation of the distance to the target surface from the receiver 106.

Triangulation devices may be built for any range scale, however the accuracy falls off rapidly with increasing range. The depth of field (minimum to maximum measurable distance) is typically limited. In addition, a triangulation system for determining distance can be spoofed by ambient light.

FIG. 2 is an example block diagram that discloses an example device for laser distance measurement using time of flight measurement. The device 202 of FIG. 2 may be an example LIDAR system. This technique measures the time taken for an optical beam to travel from the transmitter 204 of the device 202 to the target object 208 and back to the receiver 206 of the device 202. With the speed of light known, and an accurate measurement of the time taken, the distance can be calculated. The optical beam reflected from the point on the target can be measured, and the time-of-flight (ToF) from the time a pulse of the transmitted light beam is transmitted from the source to the time the pulse arrives at the sensor of the receiver 206 (e.g., photodetector) near the source or at a known location may be measured. The range from the source to the point on the target may then be determined by, for example, r=c×t/2, where r is the range from the source to the point on the target, c is the speed of light in free space, and t is the ToF of the pulse of the light beam from the source to the photodetector. Typically, many pulses for the optical beam are fired sequentially and the average response is most commonly used. This technique requires very accurate sub-nanosecond timing circuitry.

Both techniques described above, with reference to FIG. 1 (i.e., triangulation) and FIG. 2 (i.e., time-of-flight), of determining distance using light ranging may experience interference from ambient light and/or other LIDAR systems. For example, in a tourist location several tourists may be using cameras that incorporate LIDAR systems that have similar optical beams generated and reflected off of surrounding surfaces. As more LIDAR systems use commonly available laser frequencies, there will be more interference from other devices. This can be partially ameliorated by mechanical systems that align the receive sensor with the laser emitter, but this may be expensive and fragile. Furthermore, filters can help alleviate some of the interference experience from ambient light, however solar illumination contains component from several frequencies that makes it difficult and expensive to filter for the optical beam.

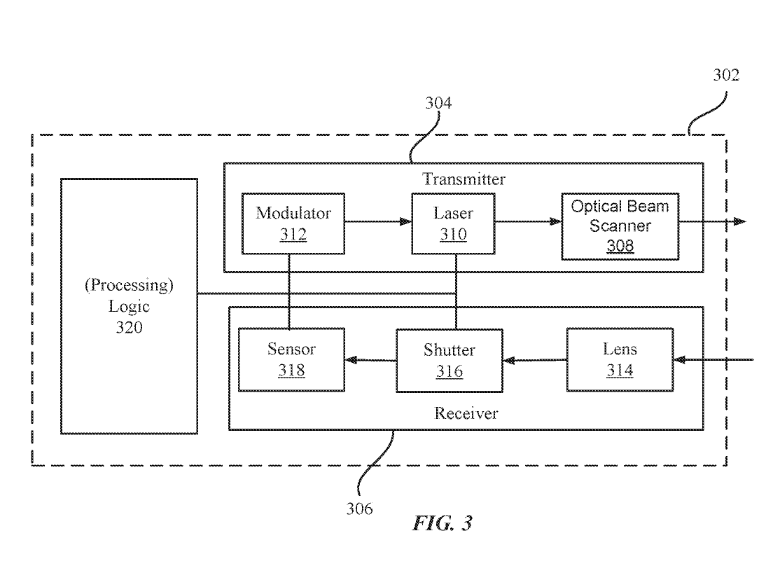

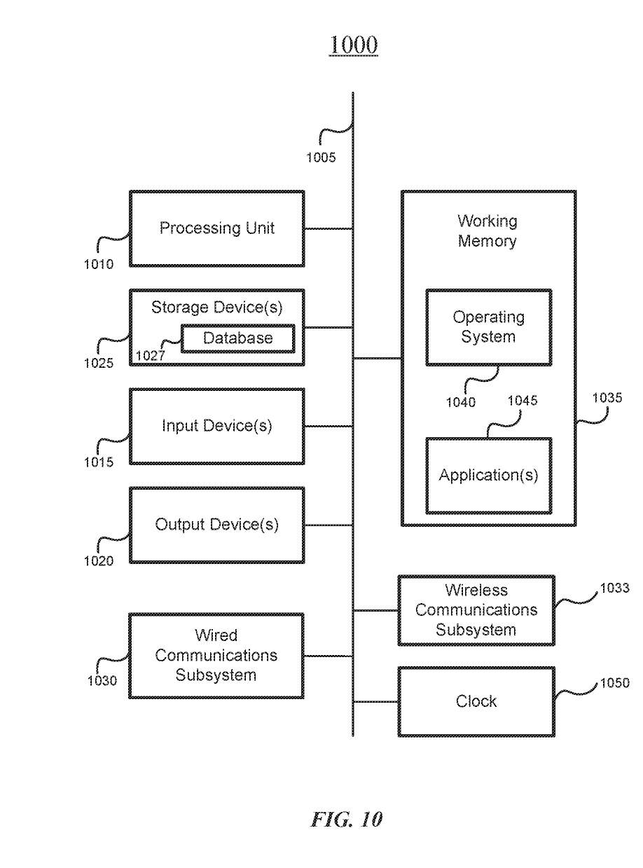

FIG. 3 is an example block diagram of an illustrative LIDAR system, according to certain aspects of the disclosure. As shown in FIG. 3, LIDAR system 302 includes a transmitter 304 and a receiver 306. Although only a few components are disclosed in FIG. 3, several other components, such as components discussed with reference to FIG. 10 may be used in conjunction with components disclosed with reference with FIG. 3. The transmitter 304 and the receiver 306 may be coupled to logic 320 for controlling certain aspects and operations of the transmitter 304 and the receiver 306. The logic 320 may be processing logic, analog logic, software/firmware executing on a processor from a processing unit 1010 operating from memory 1035, a field programmable array (FPGA), application specific integrated circuit (ASIC) or any combination thereof. It should be noted that although a single logic 320 block is shown, in certain embodiments, the transmitter 304 and the receiver 306 may have different and/or dedicated logic for their operations.

The transmitter 304 may include a modulator 312, laser 310 and an optical beam scanner 308.

The modulator 312 is coupled to the laser 310 and is used to modulate the optical beam. In one example implementation, the optical beam is modulated by modulating the current driving the laser 310, e.g. a laser diode. In certain implementations, the laser 310 emits light through a process of optical amplification based on the stimulated emission of electromagnetic radiation. The laser 310 may be, a laser diode, a vertical cavity surface-emitting laser (VCSEL), a light-emitting diode (LED), an infrared pulsed fiber laser or other mode-locked laser with an output wavelength of, for example, 930-960 nm, 1030-1070 nm, around 1550 nm, or longer. The laser 310 differs from other sources of light in that it emits coherent optical beams. Spatial coherence also allows the optical beam to stay narrow over great distances (collimation), enabling applications such as use in LIDAR systems. The laser 310 can also have high temporal coherence, which may allow it to emit optical beams with a very narrow spectrum. Temporal coherence may be useful in producing short pulses of light that can be modulated by the modulator 312.

The laser 310 is coupled to the optical beam scanner 308. The optical beam scanner 308 may include as include a light directing device, such as a scanning stage, a piezoelectric actuator, or a micro-electro mechanical systems (MEMS) device that can change the direction of the transmitted optical beam from the laser. In addition, the optical beam scanner 308 may also include a lens in some embodiments to collimate the transmitted laser beam from optical beam scanner 308 such that collimated optical beam may propagate over a long distance to a target without spreading significantly.

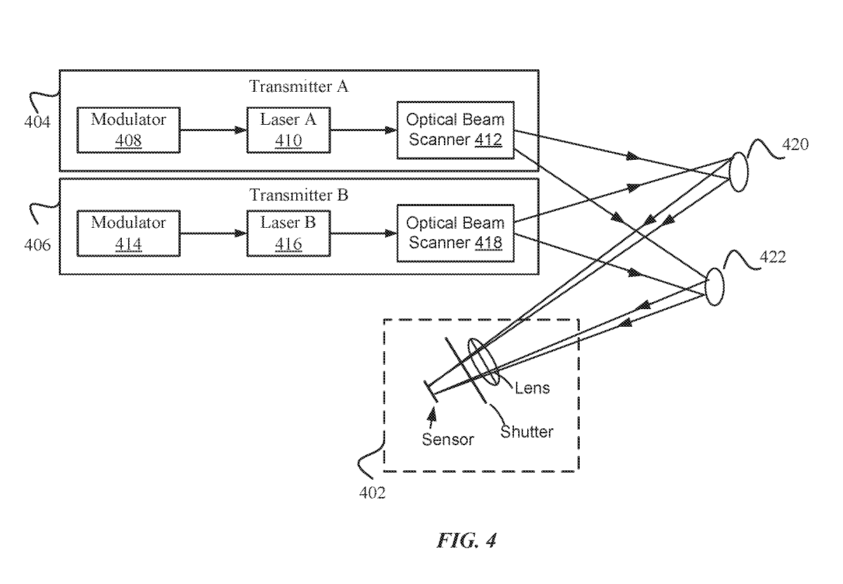

To measure ranges to multiple points on a target or in a field-of-view of the LIDAR system, the optical beam is usually scanned in one or two dimensions as shown in FIG. 4. There are many different types of optical beam scanning mechanisms, for example, a multi-dimensional mechanical stage, a Galvo-controlled mirror, a microelectromechanical (MEMS) mirror driven by micro-motors, a piezoelectric translator/transducer using piezoelectric materials such as a quartz or lead zirconate titanate (PZT) ceramic, an electromagnetic actuator, or an acoustic actuator. Laser beam scanning may also be achieved without mechanical movement of any component, for example, using a phased array technique where phases of lasers in a 1-D or 2-D laser array may be changed to alter the wave front of the superimposed laser beam. In many of these scanning mechanisms, the position of the scanning beam may be determined based on the control signals that drive the scanning mechanisms, such that the LIDAR system can determine the point on the target that reflects a particular transmitted light beam at a given time.

The receiver 306 includes a sensor 318, shutter 316 and lens 314. The lens 314 may also be used to focus the reflected optical beam from the target onto sensor 318 directly or into optical fibers connected to sensor. Sensor 318 may be a photodetector having a working (sensitive) wavelength comparable with the wavelength of the laser 310. The photodetector may be a high speed photodetector, for example, a PIN photodiode with an intrinsic region between a p-type semiconductor region and a n-type semiconductor region, or an InGaAs avalanche photodetector (APD).

In certain implementations, a physical shutter 316 may be implemented after the lens 314 and before the sensor 318. In such implementations, the shutter 316 controls the time periods for which the optical beam reaches the sensor 318. The shutter allows passage of the optical beam received at the receiver 306 of the LIDAR system 302 through the shutter 316 to the sensor 318 and closing the shutter 316 obscures the sensor 318 from receiving the optical beam received at the receiver 306 of the LIDAR system 302.

However, in certain other implementations, the shutter 316 may be a digital shutter. The digital shutter 316 may operate by disabling sensing at the sensor 318, blanking sensing at the sensor 318, or disregarding sensed information at the sensor 318 either by the sensor 318 or the processing logic 320.

FIG. 4 shows an example LIDAR system with the receiver 402 receiving optical beam reflections from multiple transmitters (404 and 406) reflected off of multiple objects (420 and 422). Transmitter A 404 may include modulator 408, laser A 410 and the optical beam scanner 412. Transmitter B 406 may include modulator 414, laser B 416 and optical beam scanner 418. Both transmitters, that is transmitter A 404 and transmitter B 406 scan the field of view using their respective optical beam scanners 412 and 418. The receiver 402 may receive reflected optical beams from transmitter A 404 and reflected optical beams from transmitter B 406 off of target object 420 and/or target object 422. In such an instance, where the receiver 402 receives optical beams from multiple sources, the reflected optical beams from one transmitter interferes with the reflected optical beams from another transmitter, because the receiver 402 cannot differentiate between the reflected optical beams from the two different transmitters.

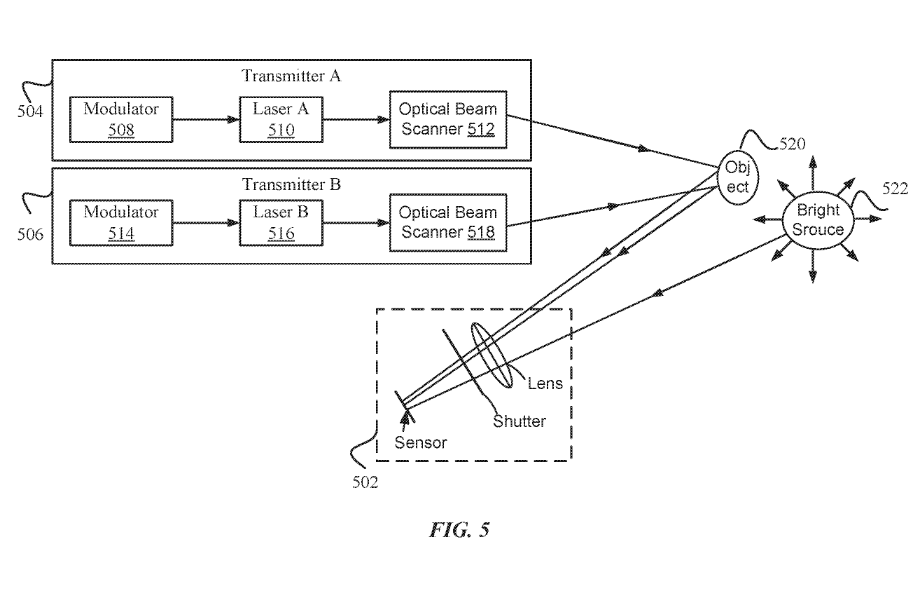

FIG. 5 is a block diagram that illustrates an example LIDAR system with the receiver 502 receiving optical beam reflections from multiple transmitters (504 and 506) reflected off of the object 520 and ambient light from a bright source, such as the sun 522. Transmitter A 504 may include modulator 508, laser A 510 and the optical beam scanner 512. Transmitter B 506 may include modulator 514, laser B 516 and optical beam scanner 518. Both transmitters, that is transmitter A 504 and transmitter B 506 scan the field of view using their respective optical beam scanners 512 and 518. The receiver 502 may receive reflected optical beams from transmitter A 504 and reflected optical beams from transmitter B 506 off of target object 520. In addition, as shown in FIG. 5, the receiver 502 receives ambient light from bright source, such as the sun 522. Solar illumination contains components from several frequencies which makes it difficult to filter out the solar illumination without filtering out the optical beam of interest. In such a scenario, the reflected beams from each other and/or the ambient light interfere with the receiver's 502 ability to identify the optical beam of interest.

As disclosed herein, according to certain aspects of the disclosure, optical modulation and demodulation may be used to uniquely identify and/or associate an optical beam with a LIDAR device. The optical beam emitting from a transmitter of the LIDAR system may be modulated with a characteristic frequency. The sensor or detector at a receiver of the LIDAR system may contain a shutter that operates relatively close to this characteristic frequency. The combination of the modulated optical beam and the shutter operating at a relatively close frequency to the modulated optical beam results in a unique signal with a “beat” frequency that can be used to identify the optical beam associated with the transmitter of the LIDAR system or the LIDAR system of interest.

Providing a signal with a “beat” frequency, as disclosed herein, in certain instances reduces the effect of the interference from the ambient light, allows identification of a certain optical beam associated with a particular LIDAR system as distinct from a plurality of optical beams from several LIDAR systems, and also allows detecting several optical beams for several different LIDAR system at the same time or substantially the same time. Furthermore, because the LIDAR device is detecting a signal with a certain “beat” frequency for a coherent signal, techniques disclosed herein can also lead to processing gain to increase the detector's signal to noise ratio.

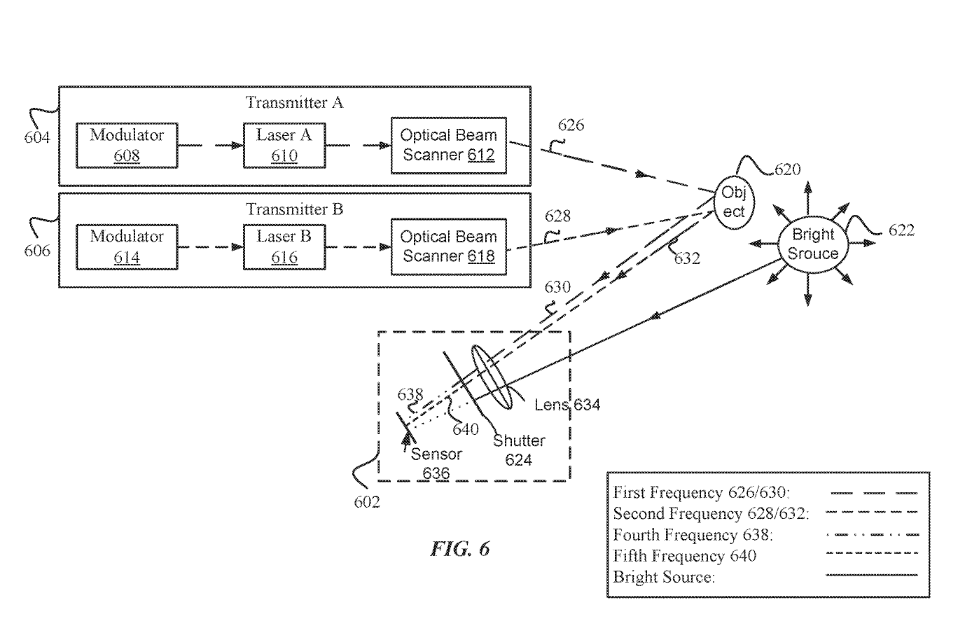

FIG. 6 is a block diagram illustrating an example LIDAR system with a receiver 602 receiving optical beam reflections from multiple transmitters (604 and 606) reflected off of object 620 and ambient light from a bright source 622. Sun is an example of a bright source 622 of light leading to ambient light. In FIG. 6, the modulator 608 of transmitter A 604 modulates the optical beam with a characteristic frequency. It should be noted that the optical beam itself has a frequency (i.e. 380 terahertz), that is much higher than the modulated characteristic frequency (e.g., around 20 KHz). The receiver 602 contains a shutter 624 that operates at a frequency relatively close to the characteristic frequency of the modulated optical beam. The combination of the modulated optical beam passing through the shutter 624 operating at a relatively close frequency to the modulated optical beam results in a signal with a unique “beat” frequency that can be used at the receiver to detect the signal and identify the optical beam associated with transmitter A 604 based on detecting of the signal.

Identifying the optical beam and its association with the transmitter using the beat frequency, as disclosed herein, in certain instances reduces the effect of the interference from the ambient light, allows identification of a certain optical beam associated with a particular transmitter/LIDAR system from a plurality of optical beams from several transmitter/LIDAR systems, and also allows detecting several optical beams for several different LIDAR systems concurrently, or substantially at the same time. Furthermore, because the LIDAR system is detecting an optical beam with a certain “beat” frequency for a coherent signal, techniques disclosed herein can also lead to processing gain to increase the detector's signal to noise ratio.

Referring back to FIG. 6, the modulator 608 of transmitter A 604 modulates the optical beam 626 generated by laser A 610 before it is transmitted by the optical beam scanner 612 with a first characteristic frequency. The optical beam 626 incident on the object 620 reflects the optical beam 630 to the receiver 602.

According to aspects of the disclosure, at the receiver 602, the shutter 624 operates at a shutter frequency relatively close to the modulation of the optical beam. In some instances, the shutter 624 may operate at close to about half the frequency of modulated optical beam. The reflected optical beam 630 (with first characteristic frequency) from transmitter A 604 passes through the lens 634. The operating of the shutter 624 at a distinct frequency than the reflected optical beam results in a signal 638 that is a further modulation of the reflected optical beam 630. After passing through the shutter 624, the signal 638 has a frequency different from the frequency originally modulated by modulator 608 for the optical beam 626/630, resulting in a unique beat frequency of the signal 638. Based on a known association, the sensor 636 and/or the processing logic 320 detect the beat frequency of the signal and appropriately associate it with the optical beam transmitted from the transmitter A 604.

The receiver 602 can monitor for a specific beat frequency associated with the optical beam 626 transmitted by the transmitter A 604 by filtering out (using a bandpass filter) optical beams for other frequencies besides the frequency for optical beam 638. The receiver 602 can reduce interference from other transmitters (e.g., transmitter B 606) and ambient light from bright sources 622, because the receiver 602 can filter out incoherent sources and sources with other frequencies than the beat frequency associated with transmitter A 604. The filtered data associated with optical beam 626 can then be used to perform the trigonometric transformations to determine the distance information given the location of the reflection.

Furthermore, according to aspects of the disclosure, as illustrated in FIG. 6, because the receiver 602 can uniquely identify different optical beams generated by different transmitters that pass through the shutter 624, based on their respective beat frequencies, the receiver 602 can monitor several optical beams concurrently.

For example, similar to transmitter A, the modulator 614 of transmitter B 606 modulates the optical beam 628 generated by laser B 616 before it is transmitted by the optical beam scanner 618 with a second characteristic frequency. The optical beam 628 incident on the object 620 reflects the optical beam 632 to the receiver 602.

As discussed previously, at the receiver 602, the reflected optical beam 632 (with the second characteristic frequency) from transmitter B 606 passes through the lens 634. The operating of the shutter 624 at the distinct frequency than the reflected optical beam 632 results in further modulation of the reflected optical beam 632. After passing through the shutter 624, the signal 640 has a frequency different from the frequency originally modulated by modulator 614 for the optical beam 628, resulting in a unique beat frequency for the signal 640. The sensor 636 and/or the processing logic 320 detects the beat frequency and appropriately associate it with the optical beam 628 transmitted from the transmitter B 606. Therefore, as illustrated in FIG. 6, transmissions from multiple transmitters may be sensed and monitored using a single receiver 602. The ambient light from a bright source also gets modulated by the shutter 624, but can be discarded by the receiver 602 as noise, avoiding the bright source from drowning the optical beams transmitted from transmitters of interest.

Table A below is an illustrative example of generating beat frequencies for each of the optical beams originating from different transmitters.

| Trans- | Modulated | Shutter | Beat | | Scan | Max pixel |
|---|---|---|---|---|---|---|
| mitter | frequency | frequency | frequency | | frequency | rate |
| A | 20000 Hz | 10000 Hz | 10000 | Hz | 21000 Hz | 2500 Hz |
| B | 19000 Hz | 10000 Hz | 9000 | Hz | 21000 Hz | 2250 Hz |

In the table above, a camera frame rate of just over 20 kilohertz is selected allowing for a potentially low cost implementation. In certain implementations, this may result in an upper limit of the beat frequency of 10 kilohertz.

Discussing Table A while referring to FIG. 6, the shutter speed for shutter 624 may be selected as 10 kilohertz. The modulator 608 for transmitter A 604 modulates the optical beam 626 at 20 kilohertz and the modulator 614 for transmitter B 606 modulates the optical beam 628 at 19 kilohertz.

The resulting beat frequency after passing the optical beam 630 (transmitted from transmitter A 604) through the shutter 624 for the optical beam 638 is 10 kilohertz. Similarly, the resulting beat frequency after passing the optical beam 632 (transmitted from transmitter B 606) through the shutter 624 for the optical beam 640 is 9 kilohertz.

In certain embodiments, a bandpass filter may be used to filter out frequencies other than the optical beam 638 modulated at 10 kilohertz and the optical beam 640 modulated at 9 kilohertz. However, each filter design (whether constructed discretely or using a processing logic 320) requires a certain amount of time to produce a response. Furthermore, the lasers illuminate a 1D or 2D area to be sensed, requiring processing of the identified optical beam over a period of time. The light reflected from objects in the laser's field is collimated by a lens 634, sent through a shutter 624 and received by an the sensor 636 situated so that the sensor captures the entire area to be sensed. Therefore, the beat frequency achieved may be sufficient to allow for capture of one “pixel” of a scene before moving on to the next pixel. If 4 cycles are desired given the specific design of the filter, then the maximum pixel timing with such a system may be 440 us, or 2250 pixels a second. In certain implementations, this may be sufficient to scan out a 48×48 matrix once a second.

The above description of FIG. 6 illustrates an embodiment using a physical shutter. In an implementation where a physical shutter is used, the passing of the reflected optical beams from transmitter A 604 and/or transmitter B 608 through the shutter results in a signal that is an optical beam. Therefore, signal 638 is an optical signal 638 with a beat frequency associated with transmitter A 604 and signal 640 is an optical signal 640 with a beat frequency associated with transmitter B 608.

However, in certain embodiments, an implicit shutter that operates digitally (i.e., digital shutter) may be used instead of an explicit or physical shutter 624 of FIG. 6. In such an embodiment, the optical beams illuminate the area to be sensed, as described with the embodiment discussed with reference to FIG. 6. The optical beams reflected from objects in the laser's field is collimated by a lens and received by an image sensor situated so that the sensor captures the entire area to be sensed. The sensor may have an inherent frame rate that may serve as an electronic shutter. For example, in some implementations, the digital or implicit shutter may be implemented by disabling sensing, blanking sensing, or disregarding sensed information for a certain period of time repeatedly at a fixed rate based on a selected frequency. In certain embodiments, blanking may refer to overriding the sensed signal. For instance, blanking may refer to turning off an amplifier so that the signal is not propagated. The operating of the digital shutter using the sensor results in transforming the reflected optical beam sensed at the sensor into a digital signal with a beat frequency associated with the transmitter. Therefore, in an implementation where an implicit or digital shutter is used, the signal generated is a digital signal. Referring back to FIG. 6, signal 638 is a digital signal 638 with a beat frequency associated with transmitter A 604 and signal 640 is an digital signal 640 with a beat frequency associated with transmitter B 608.

In another example, using a maximum pixel timing as 400 us, or 2500 pixels a second, a scan out of a 50×50 matrix once a second may be sufficient. Table B below is another illustrative example of generating beat frequencies for each of the optical beams originating from different transmitters concurrently or at substantially the same time. According to aspects of the disclosure, a single receiver can resolve the transmissions of the optical beams from the multiple transmission sources and appropriately associate the transmissions with the respective transmitters.

| Trans- | Modulated | Shutter | Beat | Fastest |
|---|---|---|---|---|
| mitter | frequency | frequency | frequency | pixel rate |
| A | 32000 Hz | 21000 Hz | 11000 Hz | 2750 Hz |
| B | 31000 Hz | 21000 Hz | 10000 Hz | 2500 Hz |

In certain embodiments, the duty cycle of the shutter and modulation may be considered in delivering the desired energy to the sensor. For example, a duty cycle of 0.707 for shutter duty cycle and the laser duty cycle would result in an intensity of 0.5 of the optical beam (i.e., total power=shutter duty*laser duty).

Again, discussing Table B while referring to FIG. 6, the shutter speed for shutter 624 may be selected as 21 kilohertz. The modulator 608 for transmitter A 604 modulates the optical beam 626 at 32 kilohertz and the modulator 614 for transmitter B 606 modulates the optical beam 628 at 31 kilohertz. In certain embodiments, as disclosed in Table B, the frame rate of the camera may be close to twice the frequency of the beat frequency.

The resulting beat frequency after the optical beam 630 passes the shutter 624 for the optical beam 638 transmitted from transmitter A 604 is 11 kilohertz. The resulting beat frequency after the optical beam 632 passes the shutter 624 for the optical beam 640 from transmitter B 606 is 10 kilohertz. In certain embodiments, a time based filter may be used to uniquely identify the optical beam 638 modulated at 11 kilohertz and the optical beam 640 modulated at 10 kilohertz.

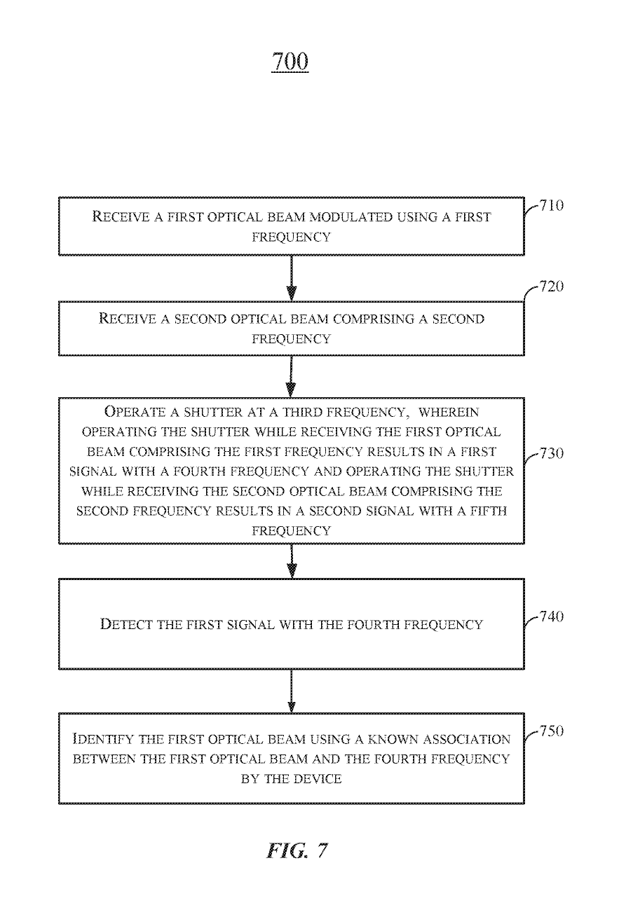

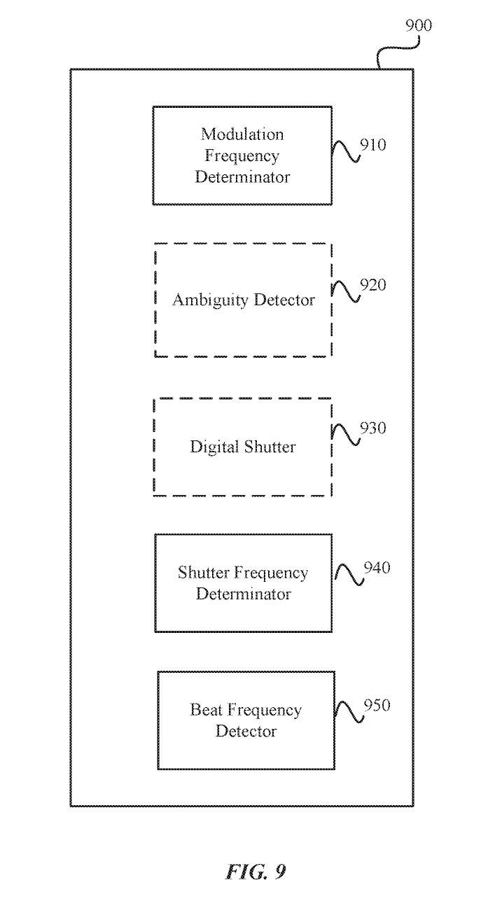

FIG. 7 is a flow diagram illustrating a method for performing embodiments of the invention according to one or more illustrative aspects of the disclosure. According to one or more aspects, any and/or all of the methods and/or method blocks described herein may be implemented by and/or in a mobile device and/or the device described in greater detail in FIG. 3 and/or FIG. 10, for instance. In one embodiment, one or more of the method blocks described below with respect to FIG. 7 are implemented by the (analog and/or digital) logic 320 of FIG. 3 and/or the processing unit 1010 of the computing device 1000, or another processor. Additionally, or alternatively, any and/or all of the methods and/or method blocks described herein may be implemented using one or more components disclosed in FIG. 3, FIG. 9 and/or FIG. 10. Furthermore, any and/or all of the methods and/or method blocks described herein may be implemented in computer-readable instructions, such as computer-readable instructions stored on a computer-readable medium such as the memory 1035, storage device(s) 1025 or another computer-readable medium.

At block 710, components of the device, such as a sensor, receives a first optical beam comprising a first frequency. At block 720, components of the device, such as the sensor receives a second optical beam comprising a second frequency. In certain implementations, a continuous wave laser may be used for gerenating the first optical beam and/or the second optical beam as coherent optical beams. A continous wave laser may generate a coherent wave that has a close to constant amplitude and frequence for the optical beam. The continous wave laser may be continously pumped and continously emit the optical beam. Furthermore, in certain embodiments, using a device similar to the device of FIG. 3, the first optical beam may be generated, using a recevier by the device, and reflected off of an object and received back at a receiver at the device.

At block 730, components of the device, such as processing logic, operates a shutter at a third frequency, wherein operating the shutter while receiving the first optical beam comprising the first frequency results in a first signal with a fourth frequency and operating the shutter while receiving the second optical beam comprising the second frequency results in a second signal with a fifth frequency. In certain implementations, the shutter may be operated using logic 320.

In certain embodiments, the shutter is a physical shutter. In such embodiments, the shutter repeatedly opens for a first period of time and closes for a second period of time. Opening of the shutter allows passage of light received at the receiver of the device through the shutter to the senor and closing the shutter obscures the sensor from receiving light received at the receiver of the device. In implementaitons where the shutter is a physical shutter the first signal and the second signal discussed in block 730 are optical signals.

In certain other embodiments, the shutter may be a digital shutter. In such embodiments, the shutter disables sensing, blanks sensing, or disregards sensed information for a first period of time repeatedly at a fixed rate based on the selected third frequency. In certain embodiments, the shutter opens and closes at close to half the speed as the modulated frequency of the first optical beam and/or the second optical beam from the transmitter. In implementations where the shutter is a digital shutter the first signal and the second signal discussed in block 730 are digital signals.

At block 740, components of the device, such as the processing logic, detects the first signal with the fourth frequency. For example, the processing logic may implement certain digital bandpass filters for detecting the signal with the fourth frequency while disregarding signals with other frequencies.

At block 750, components of the device, such as the processing logic, identifies the first optical beam using a known association between the first optical beam and the fourth frequency by the device. In certain embodiments, the processing logic may also detect the second signal with the firth frequency and identify the second optical beam using a second known association between the second optical beam and the fifth frequency by the device. The processing logic may be further configured to determine a distance of the object from the device using information associated with the first optical beam after identifying the first optical beam and/or the second optical beam after identifying the second optical beam.

It should be appreciated that the specific blocks illustrated in FIG. 7 provide a particular method of switching between modes of operation, according to an embodiment of the present invention. Other sequences of blocks may also be performed accordingly in alternative embodiments. For example, alternative embodiments of the present invention may perform the blocks outlined above in a different order. Furthermore, additional blocks or variations to the blocks may be added or removed depending on the particular applications. One of ordinary skill in the art would recognize and appreciate many variations, modifications, and alternatives of the process.

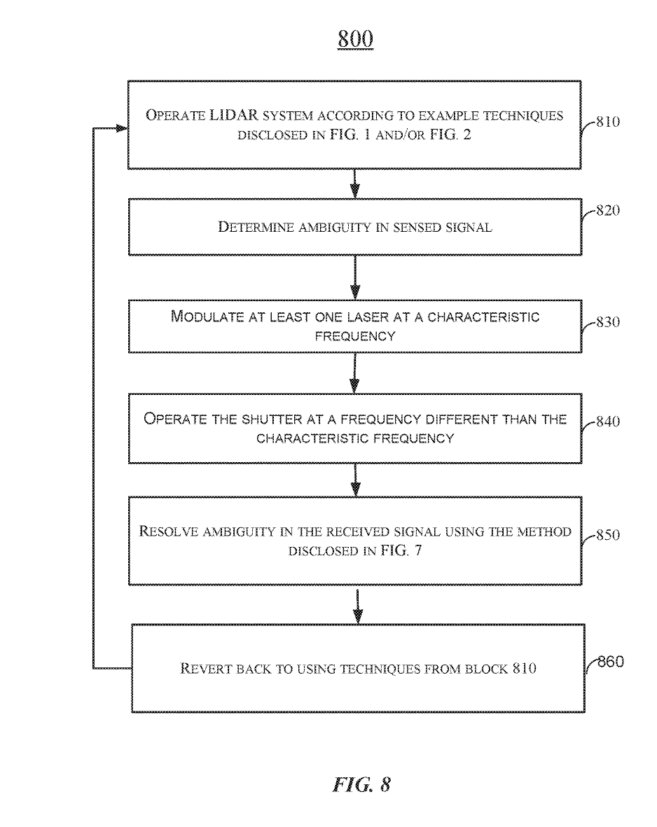

FIG. 8 is a flow diagram illustrating a method for performing embodiments of the invention according to one or more illustrative aspects of the disclosure. According to one or more aspects, any and/or all of the methods and/or method blocks described herein may be implemented by and/or in a mobile device and/or the device described in greater detail in FIG. 3 and/or FIG. 10, for instance. In one embodiment, one or more of the method blocks described below with respect to FIG. 7 are implemented by the (analog or digital) logic 320 of FIG. 3 and/or the processing unit 1010 of the computing device 1000, or another processor. Additionally, or alternatively, any and/or all of the methods and/or method blocks described herein may be implemented using one or more components disclosed in FIG. 3, FIG. 9 and/or FIG. 10. Furthermore, any and/or all of the methods and/or method blocks described herein may be implemented in computer-readable instructions, such as computer-readable instructions stored on a computer-readable medium such as the memory 1035, storage device(s) 1025 or another computer-readable medium.

At block 810, components of the LIDAR system, operate the LIDAR system using techniques and systems disclosed in FIG. 1, FIG. 2 and FIG. 3. For example, in certain implementations, the LIDAR system determines the brightest spot in the field as being the optical beam of interest. Based on determining the optical beam as the beam of interest the LIDAR system performs distance calculations using triangulation (described with reference to FIG. 1) and/or time of flight (described with reference to FIG. 2).

At block 820, components of the LIDAR system, such as the processing logic using a sensor, may determine ambiguity in sensed signal. For example, the LIDAR system may detect several bright spots and/or the LIDAR system may determine that the interference from the ambient light to the received optical beam is above a certain threshold.

At block 830, based on determining ambiguity in the detected signal at the sensor in block 820, components of the LIDAR system, such as the processing logic may modulate the optical beam at a characteristic frequency. For example, referring to FIG. 3, the processing logic 320 may interact with the modulator 312 of transmitter 304 to modulate the optical beam emitted by the transmitter 304 at a characteristic frequency.

At block 840, based on determining ambiguity in the detected signal at the sensor in block 820, components of the LIDAR system, such as the processing logic may cause the shutter to operate (e.g., close/open) at a frequency different from the characteristic frequency of block 830. The shutter may be an explicit shutter, such as a physical shutter or an implicit shutter, such as a digital shutter.

At block 850, in certain embodiments, components of the LIDAR system may resolve ambiguity in the received signal using techniques disclosed with respect to FIG. 6 and FIG. 7. For example, the processing logic 320 of FIG. 3 may identify the transmitted beam by the transmitter 304 by associating the signal at the receiver of the LIDAR system with the transmitter of the LIDAR system. For example, the received signal, may have a beat frequency unique to the transmitter 304 based on the specific characteristic frequency that the optical beam is modulated by the modulator 312 of the transmitter 304 (in block 830) and the selected frequency that the shutter 316 of the receiver 306 operates at.

At block 860, once a particular optical beam is identified as the optical beam of interest from the plurality of optical beams and/or from the ambient light, in certain instances, components of the LIDAR system may revert back to using a technique that does not modulate and demodulate the optical beam, because the optical beam of interest is now identified (block 810).

Such a hybrid system may allow the LIDAR system to provide a fast scan that may not require the additional steps for modulation, demodulation, filtering of the signal during normal operation, but a system that can adaptively switch to using aspects disclosed herein to identify optical beams of interest when ambiguity is detected.

For example, if two bright spots in the field of view are detected where the LIDAR system is expecting only one bright spot, the LIDAR system can switch the scanning mode that includes modulation, demodulation and filtering of the optical beam to determine which of the two bright spots to consider as the optical beam of interest and switch back to a fast scan.

Another example may be when the sensor is overloaded with ambient light resulting in several bright spots being detected. For example, the sensor may be overloaded with ambient light if the LIDAR system's sensor is pointed towards the light of an automobile or if the sun is reflecting off the back window. Because the sun is a thousand watts per square meter light source, it may be difficult to differentiate a normal coherent or even an incoherent source from such a bright light source. In such scenarios, according to aspects of the disclosure, the LIDAR system may switch to modulating, demodulating and filtering the optical beams to identify the optical beam associated with the transmitter of the LIDAR system.

In certain implementations, modulating, demodulating and filtering the signal, as described with respect to FIG. 6 and FIG. 7 may also be used periodically to detect and filter out other interfering LIDAR signals from consideration.

Such a hybrid system may enable maintaining fast scans while periodically or based on ambiguity switching to modulation and demodulation of optical beams disclosed herein.

It should be appreciated that the specific blocks illustrated in FIG. 8 provide a particular method of switching between modes of operation, according to an embodiment of the present invention. Other sequences of blocks may also be performed accordingly in alternative embodiments. For example, alternative embodiments of the present invention may perform the blocks outlined above in a different order. Furthermore, additional blocks or variations to the blocks may be added or removed depending on the particular applications. One of ordinary skill in the art would recognize and appreciate many variations, modifications, and alternatives of the process.

FIG. 9 is an example block diagram that discloses example logic for performing one or more aspects of the disclosure. For example, logic 900 may be similar to the logic 320 disclosed in FIG. 3. For example logic 900 may be coupled to the modulator 312 and the laser 310 of the transmitter 304 and the sensor 318 and the shutter 316 of the receiver 306 of FIG. 3. The example logic blocks of FIG. 9 that include modulation frequency determinator 910, ambiguity detector 920, digital shutter 930, shutter frequency determinator 940 and the beat frequency detector 950 may be implemented using logic 320 or processing logic from the processing unit 1010 disclosed in FIG. 10. For example, the functionality associated with such logic blocks may be executed using one or more processors from the processing unit 1010 and stored in memory 935 or a non-transient computer readable medium. In another example, one or more logic blocks from FIG. 9 may be implemented using analog circuitry or digital circuitry, such as processors, application specific integrated circuits (ASICs), field programmable gate arrays (FPGAs) or any other similar logic. Although, FIG. 9 shows a single processing block 900 including the logic blocks 910-950, each of the blocks may be implemented using discrete components. For example, some of the logic blocks or portions of some of the logic blocks may be implemented using analog circuitry and some of the logic blocks and/or portions of some of the logic blocks may be implemented using digital circuitry.

In certain implementations, the modulation frequency determinator 910 and the shutter frequency determinator 940 may work together to generate the beat frequency for the optical beam. For example, referring back to FIG. 3, the modulation frequency determinator 910 may be coupled to the modulator 312 and the laser 310. The modulation frequency determinator 910 may determine the characteristic frequency to modulate the optical beam at and configure the modulator 312 to modulate the optical beam at a characteristic frequency. Similarly, the shutter frequency determinator 940 may be configured to determine an appropriate frequency for the shutter 316 and configure the shutter to operate at the determined frequency.

In certain embodiments, an optional ambiguity detector 920 may be coupled to the modulation frequency determinator 910 and the shutter frequency determinator 940 for switching the LIDAR system momentarily or for a relatively short amount of time from a fast scanning system (that does not modulate the optical beams) to a system that modulates the optical beams to identify the optical beam of interest from the field of view, as disclosed with reference to FIG. 8. The ambiguity detector 920 may start the modulation process if multiple optical beams are detected and/or ambient light is interfering with the optical beam detection from the field of view.

In certain embodiments, the ambiguity detector 920 may also be coupled to the beat frequency detector 950 for switching the LIDAR system from a fast scanning system (that does not modulate the optical beams) to a system that modulates the optical beams to identify the optical beam of interest from the field of view, as disclosed with reference to FIG. 8. The beat frequency detector 950 may be coupled to the sensor 318 (or sensor 636 of FIG. 6) for identifying or associating an optical beam with a transmitter. In certain embodiments, the beat frequency detector 950 may know the association between the transmitter of the optical beam and the received optical beam based on knowing the modulation from the modulation frequency determinator 910 and the shutter frequency determinator 940. In certain implementations, a digital time based filter and/or an analog filter may be used for filtering out all or most of the other coherent and/or incoherent light sources for identifying the optical beam of interest. Such an implementation may also allow for increase in gain, because the logic 900 can use the specific modulation for the optical beam of interest and can filter out other optical beams and ambient light.

In certain implementations, instead of using an explicit shutter, an optional implicit digital shutter 930 may be used that operates in conjunction with the sensor 318 (or sensor 636 of FIG. 6). The digital shutter 930, based on the determined frequency from the shutter frequency determinator 940, may operate the digital shutter by disabling sensing by the sensor for specific periods of time, blanking sensing for specific periods of time, or disregarding sensed information for the specific period of time repeatedly at a fixed rate. In certain embodiments, blanking may refer to overriding the sensed signal. For instance, blanking may refer to turning off an amplifier so that the signal is not propagated. The operating of the implicit digital shutter 930 using the sensor results in transforming the reflected optical beam sensed at the sensor into a digital signal with a beat frequency.

FIG. 10 illustrates components of an example computing system 1000 for implementing some of the examples described herein. In certain instances, the computing system 1000 may be referred to as a computing device or simply as a device. For example, components of computing system 1000 can be used with FIG. 3. The processing unit 1010 of FIG. 10 may include the logic 320 of FIG. 3. It should be noted that FIG. 10 is meant only to provide a generalized illustration of various components, any or all of which may be utilized as appropriate. Moreover, system elements may be implemented in a relatively separated or relatively more integrated manner.

Computing system 1000 is shown comprising hardware elements that can be electrically coupled via a bus 1005 (or may otherwise be in communication, as appropriate). The hardware elements may include a processing unit 1010, one or more input devices 1015, and one or more output devices 1020. Input device(s) 1015 can include without limitation camera(s), a touchscreen, a touch pad, microphone(s), a keyboard, a mouse, button(s), dial(s), switch(es), and/or the like. Output devices 1020 may include without limitation a display device, a printer, light emitting diodes (LEDs), speakers, and/or the like.

Processing unit 1010 may include without limitation one or more general-purpose processors, one or more special-purpose processors (such as digital signal processing (DSP) chips, graphics acceleration processors, application specific integrated circuits (ASICs), and/or the like), and/or other processing structures or means, which can be configured to perform one or more of the methods described herein.

Computing system 1000 can also include a wired communications subsystem 1030 and a wireless communication subsystem 1033. Wired communications subsystem 1030 and wireless communications subsystem 1033 can include, without limitation, a modem, a network interface (wireless, wired, both, or other combination thereof), an infrared communication device, a wireless communication device, and/or a chipset (such as a Bluetooth™ device, an IEEE 802.11 device (e.g., a device utilizing one or more of the IEEE 802.11 standards described herein), a WiFi device, a WiMax device, cellular communication facilities, etc.), and/or the like. Subcomponents of the network interface may vary, depending on the type of computing system 1000. Wired communications subsystem 1030 and wireless communications subsystem 1033 may include one or more input and/or output communication interfaces to permit data to be exchanged with a data network, wireless access points, other computer systems, and/or any other devices described herein.

Depending on desired functionality, wireless communication subsystem 1033 may include separate transceivers to communicate with base transceiver stations and other wireless devices and access points, which may include communicating with different data networks and/or network types, such as wireless wide-area networks (WWANs), wireless local area networks (WLANs), or wireless personal area networks (WPANs). A WWAN may be, for example, a WiMax (IEEE 1002.16) network. A WLAN may be, for example, an IEEE 802.11x network. A WPAN may be, for example, a Bluetooth network, an IEEE 802.15x, or some other types of network. The techniques described herein may also be used for any combination of WWAN, WLAN and/or WPAN.

Computer system 1000 of FIG. 10 may include a clock 1050 on bus 1005, which can generate a signal to synchronize the various components on bus 1005. Clock 1050 may include an LC oscillator, a crystal oscillator, a ring oscillator, a digital clock generator such as a clock divider or clock multiplexer, a phase locked loop, or other clock generator. The clock may be synchronized (or substantially synchronized) with corresponding clocks on other devices while performing the techniques described herein.

Computing system 1000 may further include (and/or be in communication with) one or more non-transitory storage devices 1025, which can comprise, without limitation, local and/or network accessible storage, and/or can include, without limitation, a disk drive, a drive array, an optical storage device, a solid-state storage device, such as a random access memory (“RAM”), and/or a read-only memory (“ROM”), which can be programmable, flash-updateable and/or the like. Such storage devices may be configured to implement any appropriate data stores, including without limitation, various file systems, database structures, and/or the like. For instance, storage device(s) 1025 may include a database 1027 (or other data structure) configured to store detected signals as described in embodiments herein.

In many embodiments, computing system 1000 may further comprise a working memory 1035, which can include a RAM or ROM device, as described above. Software elements, shown as being currently located within working memory 1035, can include an operating system 1040, device drivers, executable libraries, and/or other code, such as one or more application programs 1045, which may comprise software programs provided by various embodiments, and/or may be designed to implement methods, and/or configure systems, provided by other embodiments, as described herein, such as some or all of the methods described in relation to FIG. 7. Merely by way of example, one or more procedures described with respect to the method discussed above might be implemented as code and/or instructions executable by a computer (and/or a processor within a computer). In an aspect, such code and/or instructions can be used to configure and/or adapt a general purpose computer (or other device) to perform one or more operations in accordance with the described methods.

A set of these instructions and/or code might be stored on a non-transitory computer-readable storage medium, such as non-transitory storage device(s) 1025 described above. In some cases, the storage medium might be incorporated within a computer system, such as computing system 1000. In other embodiments, the storage medium might be separate from a computer system (e.g., a removable medium, such as a flash drive), and/or provided in an installation package, such that the storage medium can be used to program, configure, and/or adapt a general purpose computer with the instructions/code stored thereon. These instructions might take the form of executable code, which is executable by computing system 1000 and/or might take the form of source and/or installable code, which, upon compilation and/or installation on computing system 1000 (e.g., using any of a variety of generally available compilers, installation programs, compression/decompression utilities, etc.), then takes the form of executable code.

It will be apparent to those skilled in the art that substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed.

With reference to the appended figures, components that can include memory can include non-transitory machine-readable media. The terms “machine-readable medium” and “computer-readable medium” as used herein, refer to any storage medium that participates in providing data that causes a machine to operate in a specific fashion. In embodiments provided hereinabove, various machine-readable media might be involved in providing instructions/code to processing units and/or other device(s) for execution. Additionally or alternatively, the machine-readable media might be used to store and/or carry such instructions/code. In many implementations, a computer-readable medium is a physical and/or tangible storage medium. Such a medium may take many forms, including but not limited to, non-volatile media, volatile media, and transmission media. Common forms of computer-readable media include, for example, magnetic and/or optical media, punch cards, paper tape, any other physical medium with patterns of holes, a RAM, a PROM, EPROM, a FLASH-EPROM, any other memory chip or cartridge, a carrier wave as described hereinafter, or any other medium from which a computer can read instructions and/or code.

The methods, systems, and devices discussed herein are examples. Various embodiments may omit, substitute, or add various procedures or components as appropriate. For instance, features described with respect to certain embodiments may be combined in various other embodiments. Different aspects and elements of the embodiments may be combined in a similar manner. The various components of the figures provided herein can be embodied in hardware and/or software. Also, technology evolves and, thus, many of the elements are examples that do not limit the scope of the disclosure to those specific examples.

It has proven convenient at times, principally for reasons of common usage, to refer to such signals as bits, information, values, elements, symbols, characters, variables, terms, numbers, numerals, or the like. It should be understood, however, that all of these or similar terms are to be associated with appropriate physical quantities and are merely convenient labels. Unless specifically stated otherwise, as is apparent from the discussion above, it is appreciated that throughout this specification discussions utilizing terms such as “processing,” “computing,” “calculating,” “determining,” “ascertaining,” “identifying,” “associating,” “measuring,” “performing,” or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic, electrical, or magnetic quantities within memories, registers, or other information storage devices, transmission devices, or display devices of the special purpose computer or similar special purpose electronic computing device.

Those of skill in the art will appreciate that information and signals used to communicate the messages described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Terms, “and,” “or,” and “an/or,” as used herein, may include a variety of meanings that also is expected to depend at least in part upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean any combination of A, B, and/or C, such as A, AB, AA, AAB, AABBCCC, etc.

Reference throughout this specification to “one example”, “an example”, “certain examples”, or “exemplary implementation” means that a particular feature, structure, or characteristic described in connection with the feature and/or example may be included in at least one feature and/or example of claimed subject matter. Thus, the appearances of the phrase “in one example”, “an example”, “in certain examples” or “in certain implementations” or other like phrases in various places throughout this specification are not necessarily all referring to the same feature, example, and/or limitation. Furthermore, the particular features, structures, or characteristics may be combined in one or more examples and/or features.

Some portions of the detailed description included herein may be presented in terms of algorithms or symbolic representations of operations on binary digital signals stored within a memory of a specific apparatus or special purpose computing device or platform. In the context of this particular specification, the term specific apparatus or the like includes a general purpose computer once it is programmed to perform particular operations pursuant to instructions from program software. Algorithmic descriptions or symbolic representations are examples of techniques used by those of ordinary skill in the signal processing or related arts to convey the substance of their work to others skilled in the art. An algorithm is here, and generally, is considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals, or the like. It should be understood, however, that all of these or similar terms are to be associated with appropriate physical quantities and are merely convenient labels. Unless specifically stated otherwise, as apparent from the discussion herein, it is appreciated that throughout this specification discussions utilizing terms such as “processing,” “computing,” “calculating,” “determining” or the like refer to actions or processes of a specific apparatus, such as a special purpose computer, special purpose computing apparatus or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

In the preceding detailed description, numerous specific details have been set forth to provide a thorough understanding of claimed subject matter. However, it will be understood by those skilled in the art that claimed subject matter may be practiced without these specific details. In other instances, methods and apparatuses that would be known by one of ordinary skill have not been described in detail so as not to obscure claimed subject matter. Therefore, it is intended that claimed subject matter not be limited to the particular examples disclosed, but that such claimed subject matter may also include all aspects falling within the scope of appended claims, and equivalents thereof.

For an implementation involving firmware and/or software, the methodologies may be implemented with modules (e.g., procedures, functions, and so on) that perform the functions described herein. Any machine-readable medium tangibly embodying instructions may be used in implementing the methodologies described herein. For example, software codes may be stored in a memory and executed by a processor unit. Memory may be implemented within the processor unit or external to the processor unit. As used herein the term “memory” refers to any type of long term, short term, volatile, nonvolatile, or other memory and is not to be limited to any particular type of memory or number of memories, or type of media upon which memory is stored.

If implemented in firmware and/or software, the functions may be stored as one or more instructions or code on a computer-readable storage medium. Examples include computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise RAM, ROM, EEPROM, CD-ROM or other optical disk storage, magnetic disk storage, semiconductor storage, or other storage devices, or any other medium that can be used to store desired program code in the form of instructions or data structures and that can be accessed by a computer; disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

In addition to storage on computer-readable storage medium, instructions and/or data may be provided as signals on transmission media included in a communication apparatus. For example, a communication apparatus may include a transceiver having signals indicative of instructions and data. The instructions and data are configured to cause one or more processors to implement the functions outlined in the claims. That is, the communication apparatus includes transmission media with signals indicative of information to perform disclosed functions. At a first time, the transmission media included in the communication apparatus may include a first portion of the information to perform the disclosed functions, while at a second time the transmission media included in the communication apparatus may include a second portion of the information to perform the disclosed functions.

What is claimed is:

1. A method for identifying an optical beam, comprising:
receiving, at a device, a first optical beam comprising a first frequency;
receiving, at the device, a second optical beam comprising a second frequency;
operating, by the device, a shutter at a third frequency, wherein operating the shutter while receiving the first optical beam comprising the first frequency results in a first signal with a fourth frequency and operating the shutter while receiving the second optical beam comprising the second frequency results in a second signal with a fifth frequency;
detecting, by the device, the first signal with the fourth frequency; and
identifying, by the device, the first optical beam using a known association between the first optical beam and the fourth frequency by the device.

2. The method of claim 1, wherein the first optical beam is generated by the device and reflected off of an object and received back at the device.

3. The method of claim 1, wherein the first optical beam is generated using a continuous wave laser.

4. The method of claim 2, further comprising determining a distance of the object from the device using information associated with the first optical beam after identifying the first optical beam.

5. The method of claim 1, further comprising:
detecting, by the device, the second signal with the fifth frequency; and
identifying, the second optical beam using a second known association between the second optical beam and the fifth frequency by the device.

6. The method of claim 1, wherein the second optical beam is generated by the device and reflected off of an object and received back at the device.

7. The method of claim 6, further comprising determining a distance of the object from the device using information associated with the second optical beam after identifying the second optical beam.

8. The method of claim 1, wherein the second optical beam is generated by a source other than the device.

9. The method of claim 1, wherein the shutter is a physical shutter and wherein operating the shutter at the third frequency comprises repeatedly opening the shutter for a first period of time and closing the shutter for a second period of time, wherein opening the shutter allows passage of light received at the device through the shutter to the senor and closing the shutter obscures the sensor from receiving light received at the device.

10. The method of claim 9, wherein the first signal is a third optical beam with the fourth frequency and the second signal is a fourth optical beam with the fifth frequency.

11. The method of claim 1, wherein the shutter is a digital shutter, wherein operating the shutter at the third frequency comprises disabling sensing, blanking sensing, or disregarding sensed information for a first period of time repeatedly at a fixed rate based on the selected third frequency.

12. The method of claim 11, wherein the first signal and the second signal are digital signals.

13. The method of claim 1, wherein the first frequency is at least twice the third frequency.

14. A device for identifying an optical beam, comprising:
a sensor coupled to the device and configured to:
receive a first optical beam comprising a first frequency; and
receive a second optical beam comprising a second frequency;
a shutter coupled to the sensor and configured to operate at a third frequency, wherein operating the shutter while receiving the first optical beam comprising the first frequency results in a first signal with a fourth frequency and operating the shutter while receiving the second optical beam comprising the second frequency results in a second signal with a fifth frequency; and
processing logic configured to:
detect the first signal with the fourth frequency; and
identify the first optical beam using a known association between the first optical beam and the fourth frequency by the device.

15. The device of claim 14, wherein the first optical beam is generated by a laser coupled the device and reflected off of an object and received back at the sensor.

16. The device of claim 14, wherein the first optical beam is generated using a continuous wave laser.

17. The device of claim 15, wherein the processing logic is further configured to determine a distance of the object from the device using information associated with the first optical beam after identifying the first optical beam.

18. The device of claim 14, the processing logic is further configured to:
detect the second signal with the fifth frequency; and
identify the second optical beam using a second known association between the second optical beam and the fifth frequency by the device.

19. The device of claim 14, wherein the second optical beam is generated by a laser coupled to the device and reflected off of an object and received back at the sensor.

20. The device of claim 19, wherein the processing logic is further configured to determine a distance of the object from the device using information associated with the second optical beam after identifying the second optical beam.

21. The device of claim 14, wherein the second optical beam is generated by a source other than the device.

22. The device of claim 14, wherein the shutter is a physical shutter and wherein operating the shutter at the third frequency comprises repeatedly opening the shutter for a first period of time and closing the shutter for a second period of time, wherein opening the shutter allows passage of light received at the device through the shutter to the senor and closing the shutter obscures the sensor from receiving light received at the device.

23. The device of claim 22, wherein the first signal is a third optical beam with the fourth frequency and the second signal is a fourth optical beam with the fifth frequency.

24. The device of claim 14, wherein the shutter is a digital shutter, wherein operating the shutter at the third frequency comprises disabling sensing, blanking sensing, or disregarding sensed information for a first period of time repeatedly at a fixed rate based on the selected third frequency.

25. The device of claim 24, wherein the first signal and the second signal are digital signals.

26. The device of claim 14, wherein the first frequency is at least twice the third frequency.

27. An apparatus for identifying an optical beam, comprising:
means for receiving a first optical beam comprising a first frequency;
means for receiving a second optical beam comprising a second frequency;
means for operating a shutter at a third frequency, wherein operating the shutter while receiving the first optical beam comprising the first frequency results in a first signal with a fourth frequency and operating the shutter while receiving the second optical beam comprising the second frequency results in a second signal with a fifth frequency;
means for detecting the first signal with the fourth frequency; and
means for identifying the first optical beam using a known association between the first optical beam and the fourth frequency.

28. The apparatus of claim 27, wherein the first optical beam is generated using a continuous wave laser.

29. A non-transitory computer-readable storage medium including machine-readable instructions stored thereon for:
receiving a first optical beam comprising a first frequency;
receiving a second optical beam comprising a second frequency;
operating a shutter at a third frequency, wherein operating the shutter while receiving the first optical beam comprising the first frequency results in a first signal with a fourth frequency and operating the shutter while receiving the second optical beam comprising the second frequency results in a second signal with a fifth frequency;
detecting the first signal with the fourth frequency; and
identifying the first optical beam using a known association between the first optical beam and the fourth frequency.

30. The non-transitory computer-readable storage medium of claim 29, wherein the first optical beam is generated using a continuous wave laser.
